(19) United States
(12) Patent Application Publication
(10) Pub. No.: US 2014/0262615 A1
(43) Pub. Date: Sep. 18, 2014

(54) BRACKET ASSEMBLY

(71) Applicant: G. Michael Copp, Strathroy (CA)

(72) Inventor: G. Michael Copp, Strathroy (CA)

(21) Appl. No.: 13/803,110

(22) Filed: Mar. 14, 2013

(51) Int. Cl. E06C 7/18

(52) U.S. Cl. CPC E06C 7/188
USPC 182/107; 248/205.1; 248/231.9; 29/428

(57) ABSTRACT

A bracket assembly for supporting a ladder positioned substantially orthogonal to a wall. The bracket assembly includes a body portion for engagement with one or more parts of the ladder, to support the ladder and to at least partially locate the ladder in a predetermined position relative to the wall. The bracket assembly also includes an attachment subassembly secured to the body portion, for releasable attachment to the wall.

### FIELD OF THE INVENTION

The invention is a bracket assembly for supporting a ladder positioned substantially orthogonal to a wall.

### BACKGROUND OF THE INVENTION

As is well known in the art, a trench box typically is used to temporarily support opposing side walls of an excavated trench. The prior art trench box includes at least two trench box walls between which a lower surface of the trench is located. The trench box walls are intended to prevent collapse of the side walls of earth adjacent the trench into the trench, thereby permitting workers to work safely in the trench. For example, trench boxes may be used where a new pipeline is installed. As is well known in the art, once the work in the trench has been completed and the trench may be backfilled, the trench box is removed, and moved to another part of the excavated trench, or to another trench. Subsequently, the part of the trench where the trench box has been removed is backfilled.

After the initial excavation of the trench, the trench box is installed. Typically, the workers are initially located on an upper surface (i.e., the ground surface), and need access to the lower surface in order to do the work required in the trench. In the prior art, access between the upper surface and the lower surface in the trench is provided by leaning a ladder against the trench box wall. Typically, a lower end of the ladder is positioned on the lower surface (i.e., inside the trench box) at a distance from the trench box wall, and an upper end of the ladder is engaged with the trench box wall, at an upper end thereof. When the ladder is leaned against the trench box wall in this way, the ladder is considered to be located substantially parallel to the trench box wall, i.e., rungs of the ladder are located substantially parallel to the trench box wall.

As is well known in the art, this arrangement is temporary in nature. Once the work is done in the trench, the ladder can be removed, after which the trench box is removed, and the trench is backfilled.

However, there are some disadvantages to the prior art arrangement involving leaning a ladder parallel to the trench box wall against the trench box wall, described above. First, because the lower surface was recently excavated, the lower end of the ladder may shift or tilt when the ladder is in use. In the prior art, to prevent movement of the ladder relative to the wall when a worker is on the ladder, the upper end of the ladder may be tied to the wall, at the wall's upper end. However, this is generally done on an ad hoc basis, and consequently the safety of this may be questionable. For example, the trench box wall may not include holes or rings to which the upper end of the ladder may be secured, and often the upper end of the ladder is not well-secured to the trench box wall as a result.

Also, when a worker steps from the upper end of the ladder to the upper surface or vice versa, the worker is obligated to extend his body, and reach around the ladder. This maneuver is potentially unsafe.

### SUMMARY OF THE INVENTION

For the foregoing reasons, there is a need for a bracket assembly that overcomes or mitigates one or more of the disadvantages of the prior art.

In its broad aspect, the invention provides a bracket assembly for supporting a ladder positioned substantially orthogonal to a wall. The bracket assembly includes a body portion for engagement with at least one part of the ladder, to support the ladder and to at least partially locate the ladder in a predetermined position relative to the wall. The bracket assembly also includes an attachment subassembly secured to the body portion, for releasable attachment to the wall.

In another aspect, the invention provides a system for providing access between an upper surface and a lower surface in a trench, the trench being at least partially defined by trench box walls of a trench box. The system includes a ladder and a bracket assembly for supporting the ladder in a predetermined relation to a selected one of the trench box walls. The bracket assembly includes a body portion for engagement with one or more parts of the ladder, for locating the ladder substantially orthogonal to the selected one of the trench box walls, and an attachment subassembly secured to the body portion, for releasable attachment to the selected one of the trench box walls.

In yet another embodiment, the invention provides a method of providing means for access between a lower surface in a trench and an upper surface, the trench being at least partially defined by one or more trench box walls. The method includes the step of providing a ladder extending between upper and lower ends thereof, and providing a bracket assembly for supporting the upper end of the ladder. The bracket assembly is mounted on the trench box wall. Next, the ladder is positioned substantially orthogonal to said at least one trench box wall, with the lower end of the ladder located on the lower surface. Finally, the upper end of the ladder is positioned to engage at least a part of the ladder with the bracket assembly, such that the bracket assembly supports the upper end of the ladder.

### BRIEF DESCRIPTION OF THE DRAWINGS

The invention will be better understood with reference to the attached drawings, in which:

FIG. 1 is an isometric view of an embodiment of a bracket assembly of the invention;

FIG. 2A is a top view of the bracket assembly of FIG. 1;

FIG. 2B is a top view of the bracket assembly of FIG. 1 in which the bracket assembly is secured to a trench box wall by fasteners;

FIG. 2C is a top view showing foot elements mounted on bolts included in the fasteners of the bracket assembly of FIG. 2B engaged with the trench box wall, drawn at a larger scale;

FIG. 2D is a cross-section of a trench at least partially defined by the trench box walls and the bracket assembly of FIG. 1 mounted on a selected one of the trench box walls, drawn at a smaller scale;

FIG. 3 is an isometric view of an alternative embodiment of the bracket assembly of the invention mounted on the trench box wall, drawn at a larger scale;

FIG. 4 is another isometric view of the bracket assembly of FIG. 3;

FIG. 5 is an isometric view of an alternative embodiment of the bracket assembly of the invention;

FIG. 6 is an isometric view of the bracket assembly of FIG. 5 mounted on the trench box wall with a ladder supported by the bracket assembly;

FIG. 7 is another isometric view of the bracket assembly of FIG. 6;

FIG. 8 is another isometric view of the bracket assembly of FIG. 6, drawn at a smaller scale; and

FIG. 9 is a schematic illustration of an embodiment of a method of the invention.

### DETAILED DESCRIPTION

In the attached drawings, like reference numerals designate corresponding elements throughout. Reference is made to FIGS. 1-2D to describe an embodiment of a bracket assembly of the invention referred to generally by the numeral 20. As will be described, the bracket assembly 20 is for supporting a ladder 22 positioned substantially orthogonal to a wall 24 (FIGS. 2B, 2D). In one embodiment, the bracket assembly 20 preferably includes a body portion 26 for engagement with one or more parts 28 of the ladder 22, to support the ladder 22 and to at least partially locate the ladder 22 in a predetermined position relative to the wall 24 (FIG. 2D). Preferably, and as can be seen in FIG. 1, the bracket assembly 20 also includes an attachment subassembly 30 secured to the body portion 26, for releasable attachment to the wall 24.

As can be seen in FIG. 2D, when the ladder 22 is supported by the bracket assembly 20 in the predetermined position relative to the trench box wall 24, the ladder 22 provides access from an upper surface “U” to a lower surface “L” that at least partially defines a trench “T”.

As can be seen in FIGS. 1-2B, in one embodiment, the body portion 26 preferably includes one or more lateral elements 32 for engagement with the part 28 of the ladder 22. The lateral elements 32 preferably are connected to each other by an inner connecting element 33, as will be described. Also, in one embodiment, the attachment subassembly 30 preferably includes one or more engagement elements 34 at least partially formed for mounting on the wall 24, and one or more fasteners 36 for releasably securing the engagement element 34 to the wall 24 (FIG. 1). As can be seen in FIG. 1, it is preferred that the engagement element 34 defines a channel 38 in which a preselected portion of the wall 24 is receivable, as will also be described.

As can be seen in FIGS. 1 and 2A, in one embodiment, the attachment subassembly 30 preferably includes two engagement elements, designated 34A and 34B in FIG. 1 for clarity of illustration. Preferably, each of the engagement elements 34A, 34B is generally in the shape of an inverted “U”, to define the channel 38. Each of the engagement elements 34A, 34B preferably has an inner leg “X”, a central portion “Y”, and an outer leg “Z”. As can be seen in FIGS. 1 and 2A, in one embodiment, the outer legs “Z” of the engagement elements 34A, 34B preferably are connected to each other by an outer connecting element 39. It is preferred that the outer connecting element 39 is attached to respective outer surfaces of the outer legs “Z” of the engagement elements 34A, 34B. Similarly, the inner connecting element 33 preferably is attached to outer surfaces of the inner legs “X” of the engagement elements 34A, 34B.

Those skilled in the art would appreciate that, in order that the channels 38 defined by the engagement elements 34 are located substantially parallel to each other, each of the inner and outer connecting elements 33, 39 preferably is substantially straight. Because of this arrangement, a part of the wall 24 is receivable in the channels 38, i.e., when the bracket assembly 20 is positioned on the wall 24.

Preferably, the fastener 36 is any suitable fastener. Those skilled in the art would be aware of various fasteners that may be used to releasably secure the engagement element 34 to the wall 24. In one embodiment, the engagement element 34 preferably includes one or more holes 40 therein, and the fastener 36 preferably also includes one or more threaded bolts 42. Preferably, each of the holes 40 is threaded, for threadable engagement of the threaded bolt 42 therein, so that the bolt 42 imposes a load on the wall 24 when the bolt 42 is suitably rotated (i.e., tightened) in the threaded hole 40.

The bolt 42 preferably is formed with a nut 44 at one end thereof, for facilitating both tightening the bolt 42 and its removal. As can be seen, for instance, in FIG. 1, in one embodiment, the bolt and nut preferably are conventional. In one embodiment, the fastener 36 preferably also includes a foot element 44 mounted on a selected end 46 of the bolt 42 for distributing the load imposed on the wall 24 by the bolt 42, when the attachment subassembly 30 is secured to the wall 24 (FIG. 2B). As can be seen in FIG. 2C, it is preferred that the foot element 44 has a second diameter “D₂” larger than a first diameter “D₁” of the bolt 42, for broader distribution of the load over a portion of the wall 24 engaged by the foot element 44 when the bolt 42 is tightened. It will be understood that the engagement elements 34 and certain other elements of the bracket assembly 20 are omitted from FIG. 2C for clarity of illustration.

Those skilled in the art would appreciate that the foot elements 44 permit secure attachment of the engagement element 34 to the wall 24. Also, the foot elements 44 facilitate removal of the engagement element 34 from the wall 24, and provide some protection to the wall 24. In the absence of the foot elements 44, the ends of the bolts 42 would tend to press into the wall 24, possibly marking or damaging the wall 24.

Preferably, when the attachment subassembly 30 is secured to the wall 24 (as shown in FIG. 2B), at least part of the lateral element 32 extends substantially orthogonal relative to the wall 24 between an outer end 46, located proximal to the attachment subassembly 30, and an inner end 48, distal to the attachment subassembly 30 to locate the ladder 22 substantially parallel to the lateral element 32 when the part 28 of the ladder 22 engages the lateral element 32. It is also preferred that the lateral element 32 is secured to the inner connecting element 33 at the lateral element's outer end 46 (FIG. 2A). In one embodiment, the part 28 of the ladder 22 engaging the lateral element 32 is located between the attachment subassembly 30 and a stop element 50 positioned on the lateral element 32 distal to the attachment subassembly 30. Preferably, the lateral element 32 is secured to the stop element 50 at the lateral element's inner end 48.

As can be seen in FIG. 2B, the stop element 50 prevents the part 28 of the ladder 22 from sliding inwardly (i.e., in the direction indicated by arrow “A” in FIG. 2B). That is, the stop element 50 preferably is positioned for keeping the part 28 of the ladder 22 engaged with the lateral element 32.

In one embodiment, the body portion 26 preferably includes a second lateral element 51, for supporting the lateral element 32. As can be seen in FIG. 1, it is preferred that the second lateral element 51 is located substantially parallel to the lateral element 32. As can also be seen in FIG. 1, the stop element 50 preferably connects the lateral element 32 and the second lateral element 51, and the inner connecting element 33 also is attached to both the lateral elements 32, 51, thereby enabling the second lateral element 51 to support the lateral element 32. Also, a user alternatively may position the part 28 of the ladder 22 against the second lateral element 51, if desired. The embodiment of the bracket assembly 20 illustrated in FIGS. 1-2D thus has the advantage of versatility.

As can be seen in FIGS. 1-2B, the bracket assembly 20 preferably includes two fasteners, identified for convenience in FIG. 2B as 36A and 36B. Preferably, the holes (designated 40A, 40B respectively in FIG. 2B for convenience) and the fasteners 36A, 36B are spaced apart from each other by a distance “M” so that they are both located further away from a center line “C” of the bracket assembly 20 than the lateral element 32 and the second lateral element 51 (FIG. 2B). Because of this, when the engagement element 34 is secured to the trench box wall 24 by the fasteners 36A, 36B, the bracket assembly 20 is resistant to pivoting thereof about the center line “C”.

Preferably, the bracket assembly 20 is made of any suitable material, or materials. For instance, the bracket assembly 20 may be made of any suitable steel, with certain elements thereof welded together.

An alternative embodiment of the bracket assembly 120 of the invention is illustrated in FIGS. 3 and 4. In the bracket assembly 120, a second lateral element 151 is secured to a first lateral element 132 and is positioned to define an acute angle therebetween.

In one embodiment, the bracket assembly 120 preferably also includes a fastening element 152 to which the ladder 22 is fastenable via a securing element 154 thereof. As can be seen in FIG. 3, it is also preferred that the bracket assembly 120 includes a body portion 126 having a lateral element 132, and the securing element(s) 154 are located on the lateral element 132. The securing element 154 preferably is any suitable, flexible element that may be used to tie the part 28 of the ladder 22 to the fastening element 152, to substantially prevent movement of the part 28 relative to the lateral element 132. The securing element 154 is intended to temporarily secure the upper end of the ladder 22 to the body portion 126, so that the ladder 22 is substantially stable relative to the body portion 126. The securing element 154 may be secured to the bracket assembly 20 at a suitable location thereon. Preferably, the fastening element 152 defines an aperture 156 therein through with the fastening element 152 may be at least partially positioned. For instance, the securing element 154 may be drawn through the aperture 156 and tied, to secure the ladder 22 to the bracket assembly 120.

As can be seen in FIGS. 3 and 4, the bracket assembly 120 preferably includes a brace element 157 for supporting the lateral element 132. In one embodiment, it is preferred that the brace element 157 is non-parallel to the lateral element 132. The brace element 157 preferably extends between inner and outer ends 158, 159 thereof. The inner end 158 preferably is secured to the lateral element 132 at an inner end 148 of the lateral element 132. The outer end 159 of the brace element 157 preferably is secured to an attachment subassembly 130 of the bracket assembly 120 at a predetermined distance “N” (FIG. 3) from the lateral element 132 at an outer end 146 thereof.

It will be understood that the fastening element may be included in all embodiments of the bracket assembly. It will also be understood that the fastening element is omitted from FIGS. 1-2B and 5-8 for clarity of illustration.

In use, the engagement element 34 of the bracket assembly 20 is secured to the trench box wall 24. The ladder 22 is then positioned with the upper end thereof supported by the lateral element 32 of the body portion 26, and with the lower end of the ladder 22 located on the lower surface of the trench (FIG. 2D). As described above, the part 28 of the upper end of the ladder may be fastened to the body portion 26 by a fastening element (not shown in FIGS. 1-2C), which is tied to one or more securing elements 54 (FIGS. 1, 2A) included in the body portion 26.

In FIG. 9, an embodiment of a method 261 of the invention is schematically illustrated. The method 261 is for providing means for access between the lower surface in a trench and the nearby upper surface, the trench being at least partially defined by the trench box walls 24. Preferably, the method 261 includes the steps of, first, providing the ladder 22 extending between upper and lower ends thereof (FIG. 9, step 263). Next, the bracket assembly 20 for supporting the upper end of the ladder is provided (step 265). The bracket assembly 20 is then mounted on the trench box wall 24 (step 267). Next, the ladder 22 is positioned substantially orthogonal to the trench box wall 24, with the lower end of the ladder 22 located on the lower surface “L” (step 269). Finally, the upper end of the ladder is positioned to engage at least the part 28 of the ladder 22 with the bracket assembly 20, so that the bracket assembly 20 supports the upper end of the ladder 22 (step 271).

Preferably, the bracket assembly 20 is releasably secured to said at least one trench box wall with one or more fasteners 36. Also, in one embodiment, the method of the invention additionally includes the steps of preferably securing the upper end of the ladder to the bracket assembly.

An alternative embodiment of a bracket assembly 320 of the invention is illustrated in FIGS. 5-8. As can be seen in FIG. 5, the bracket assembly 320 preferably includes an engagement element 334 which additionally includes one or more ribs 380, for strengthening the engagement element 334.

As can be seen in FIGS. 5-8, the bracket assembly 320 preferably includes a body portion 326 and an attachment subassembly 330. The bracket assembly 320 preferably includes two engagement elements, identified in FIG. 5 for convenience as 334A and 334B. The elements 334A and 334B preferably are connected by an outer connecting element 339 and an inner connecting element 333 (FIG. 5).

Those skilled in the art would appreciate that the ribs 380 are added to strengthen each of the engagement elements 334A, 334B. Preferably, two ribs are formed on each of the engagement elements respectively, and they are formed and sized to materially strengthen each of the engagement elements 334A, 334B respectively.

In one embodiment, a system 482 of the invention provides access between the upper surface “U” and the lower surface “L” in the trench “T” (FIG. 2D). The trench is at least partially defined by the trench box walls 24 of the trench box. The system 482 includes the ladder 22, and the bracket assembly 20 for supporting the ladder 22 in a predetermined relation to a selected one of the trench box walls. The bracket assembly 20 includes the body portion 26 for engagement with the part 28 of the ladder 22, for locating the ladder 22 substantially orthogonal to the selected one of the trench box walls. As noted above, the bracket assembly 20 preferably also includes the attachment subassembly 30 secured to the body portion 26, for releasable attachment to the selected one of the trench box walls. In one embodiment, and as noted above, the body portion 26 preferably includes the lateral element 32 for engagement with the part 28 of the ladder, and the stop element 50 positioned on the lateral element 32, for keeping the part 28 of the ladder engaged with the lateral element 32.

It will be appreciated by those skilled in the art that the invention can take many forms, and that such forms are within the scope of the invention as described above. The foregoing descriptions are exemplary, and their scope should not be limited to the preferred versions provided therein.

I claim:

1. A bracket assembly for supporting a ladder positioned substantially orthogonal to a wall, the bracket assembly comprising:
a body portion for engagement with at least one part of the ladder, to support the ladder and to at least partially locate the ladder in a predetermined position relative to the wall; and
an attachment subassembly secured to the body portion, for releasable attachment to the wall.

2. A bracket assembly according to claim 1 in which the body portion comprises at least one lateral element for engagement with said at least one part of the ladder.

3. A bracket assembly according to claim 2 in which the attachment subassembly comprises:
at least one engagement element at least partially formed for mounting on the wall; and
at least one fastener for releasably securing said at least one engagement element to the wall.

4. A bracket assembly according to claim 3 in which said at least one engagement element defines a channel in which a preselected portion of the wall is receivable.

5. A bracket assembly according to claim 3 in which:
said at least one engagement element comprises at least one hole therein;
said at least one fastener comprises at least one threaded bolt;
said at least one hole is threaded, for threadable engagement of said at least one threaded bolt therein such that said at least one bolt imposes a load on the wall when said at least one bolt is tightened in said at least one threaded hole.

6. A bracket assembly according to claim 5 in which said at least one fastener comprises a foot element mounted on a selected end of said at least one bolt for distributing the load imposed on the wall by said at least one bolt when the attachment subassembly is secured to the wall.

7. A bracket assembly according to claim 6 in which the foot element has a second diameter larger than a first diameter of said at least one threaded bolt, for broader distribution of the load over a portion of the wall engaged by the foot element when said at least one bolt is tightened.

8. A bracket assembly according to claim 2 in which, when the attachment subassembly is secured to the wall, at least part of said at least one lateral element extends substantially orthogonally relative to the wall between an outer end, located proximal to the attachment subassembly, and an inner end, distal to the attachment subassembly to locate the ladder substantially parallel to said at least one lateral element when said at least one part of the ladder engages said at least one lateral element.

9. A bracket assembly according to claim 8 in which said at least one part of the ladder engaging said at least one lateral element is located between the attachment subassembly and a stop element positioned distal to the attachment subassembly.

10. A bracket assembly according to claim 8 in which the body portion additionally comprises at least one stop element positioned for keeping said at least one part of the ladder engaged with said at least one lateral element.

11. A bracket assembly according to claim 9 in which the body portion additionally comprises at least one fastening element to which the ladder is securable via a securing element thereof.

12. A bracket assembly according to claim 3 in which said at least one engagement element additionally comprises at least one rib, for strengthening said at least one engagement element.

13. A system for providing access between an upper surface and a lower surface in a trench, the trench being at least partially defined by trench box walls of a trench box, the system comprising:
a ladder;
a bracket assembly for supporting the ladder in a predetermined relation to a selected one of the trench box walls;
the bracket assembly comprising:
a body portion for engagement with at least one part of the ladder, for locating the ladder substantially orthogonal to the selected one of the trench box walls; and
an attachment subassembly secured to the body portion, for releasable attachment to the selected one of the trench box walls.

14. A system according to claim 13 in which the attachment subassembly comprises:
at least one engagement element at least partially formed for mounting on the selected one of the trench box walls; and
at least one fastener for releasably securing said at least one engagement element to the selected one of the trench box walls.

15. A system according to claim 14 in which the body portion comprises:
at least one lateral element for engagement with said at least one part of the ladder; and
at least one stop element positioned for keeping said at least one part of the ladder engaged with said at least one lateral element.

16. A system according to claim 15 in which the body portion additionally comprises at least one brace element for supporting said at least one lateral element.

17. A system according to claim 16 in which the body portion comprises at least one fastening element to which the ladder is securable via a securing element thereof.

18. A method of providing means for access between a lower surface in a trench and an upper surface, the trench being at least partially defined by at least one trench box wall, the method comprising:
(a) providing a ladder extending between upper and lower ends thereof;
(b) providing a bracket assembly for supporting the upper end of the ladder;
(c) mounting the bracket assembly on said at least one trench box wall;
(d) positioning the ladder substantially orthogonal to said at least one trench box wall, with the lower end of the ladder located on the lower surface; and
(e) positioning the upper end of the ladder to engage at least a part of the ladder with the bracket assembly, such that the bracket assembly supports the upper end of the ladder.

19. A method according to claim 18 additionally comprising:
(f) securing the upper end of the ladder to the bracket assembly.

20. A method according to claim 18 in which the bracket assembly is releasably secured to said at least one trench box wall with at least one fastener.
